(19) United States
(12) Patent Application Publication
(10) Pub. No.: US 2011/0164187 A1
(43) Pub. Date: Jul. 7, 2011

(54) Remote Control Method, Remote Control System and Display Device

(76) Inventor: Ching-An Lin, Taipei Hsien (TW)

(21) Appl. No.: 12/889,404

(22) Filed: Sep. 23, 2010

(30) Foreign Application Priority Data
Jan. 5, 2010 (TW) 099100090

(51) Int. Cl. H04N 5/44

(52) U.S. Cl. 348/734; 348/E05.096

(57) ABSTRACT

A remote control method for a display device employing a hierarchical control frame, includes a remote controller of the display device outputting a control signal corresponding to a plurality of functions of the display device, and an interpretation module of the display device controlling the display device to perform the plurality of functions when receiving the control signal, wherein the plurality of functions are corresponding to different stages of the hierarchical control frame.

### BACKGROUND OF THE INVENTION

1. Field of the Invention

The present invention relates to a remote control method, remote control system and display device, and more particularly, to a remote control method, remote control system and display device capable of effectively enhancing operation efficiency of the display device, and further fulfilling personalized requirements.

2. Description of the Prior Art

With progress of entertainment and multimedia industries, TV sets have become the dominant leisure equipments for most people, which can display cable and broadcast TV programs, or display images provided by certain devices via related interfaces, such as DVD player, blue-ray player, game console, and computer system. Meanwhile, with technique developments, the TV sets have great improvements not only in display quality, but also in functionalities. Functions such as recording, picture in picture, memory card reading, and automatic light adjustment are gradually equipped in latest products.

In the past, there are only two methods to control a TV set. One is pressing keys or keystrokes installed on a housing of the TV set, while the other is using a remote controller. Take the remote controller for an example. When a user intends to operate the TV set to execute a certain function, such as adjusting volume, the user can press a key corresponding to the function on the remote controller, making the remote controller to output a remote control signal. After receiving the remote control signal, the TV set performs related functions accordingly. Additionally, as a TV set includes more multimedia functions, items or output parameters controlled by the corresponding remote controller become more complex, not limited in channel switching or volume adjusting. Under such circumstances, in order not to deposit too many keys in the remote controller, the prior art utilizes a hierarchical control frame to control the TV set, allowing the remote controller to control tens or even hundreds of functions or output parameters with a few keys for menu controls (such as up/down, left/right, confirm, cancel, etc.). For example, when adjusting the contrast of the TV set via the remote controller, the user first uses the remote controller to call a main menu displayed on the TV screen, then selects a sub menu corresponding to display parameters from the main menu, and at last selects a contract item from the sub menu to adjust the contract.

Via the hierarchical control frame, the complex functions or output parameters can be categorized into different sub menus, while all of the sub menus constitute the main menu. However, such operations lack flexibility. That is, the user cannot rapidly adjust one or multiple output parameters. Also, the TV set cannot rapidly provide personalized settings for different users.

Therefore, there is a need to improve the prior art.

### SUMMARY OF THE INVENTION

It is therefore a primary objective of the claimed invention to provide a remote control method, remote control system and display device.

The present invention discloses a remote control method for a display device employing a hierarchical control frame, which includes a remote controller of the display device outputting a control signal corresponding to a plurality of functions of the display device, and an interpretation module of the display device controlling the display device to perform the plurality of functions when receiving the control signal, wherein the plurality of functions are corresponding to different stages of the hierarchical control frame.

The present invention further discloses a remote control system for a display device employing a hierarchical control frame, which includes a macro key, formed in a remote controller, for generating a control signal corresponding to a plurality of functions of the display device, and an interpretation module, for controlling the display device to perform the plurality of functions when the display device receives the control signal generated by the macro key, wherein the plurality of functions are corresponding to different stages of the hierarchical control frame.

The present invention further discloses a display device employing a hierarchical control frame, which includes a monitor, a processing module, for displaying images via the monitor, a remote controller a reception module, for receiving the wireless signal outputted from the remote controller and extracting contents of the wireless signal to generate an identification result, and an interpretation module, for controlling the processing module to execute the plurality of functions when the identification result equals the control signal generated by the macro key. The remote controller includes an emitting module, for outputting a wireless signal, and a macro key, for generating a control signal corresponding to a plurality of functions of the processing module, and outputting the control signal as the wireless signal via the emitting module. The plurality of functions are corresponding to different stages of the hierarchical control frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a structure schematic diagram of a display device according to an embodiment of the present invention.

FIG. 1B is a block diagram of the display device in FIG. 1A.

FIG. 2A to FIG. 2D illustrate a schematic diagram of controlling the display device via basic function keys shown in FIG. 1B.

FIG. 3 illustrates a schematic diagram of controlling the display device via a macro key shown in FIG. 1B.

FIG. 4 illustrates a schematic diagram of controlling the display device via a macro key shown in FIG. 1B.

FIG. 5 is a schematic diagram of a remote control process according to an embodiment of the present invention.

### DETAILED DESCRIPTION

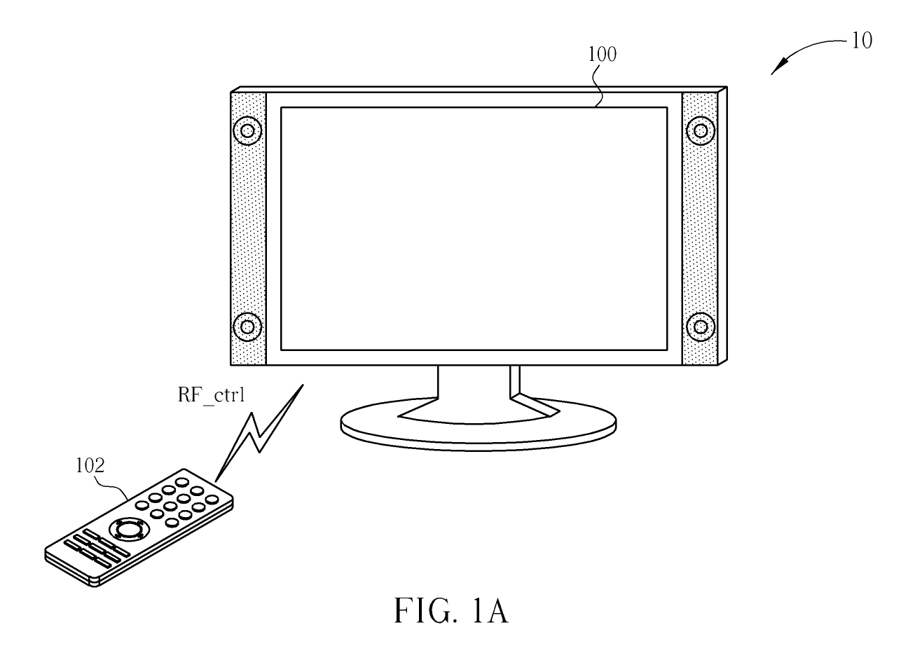

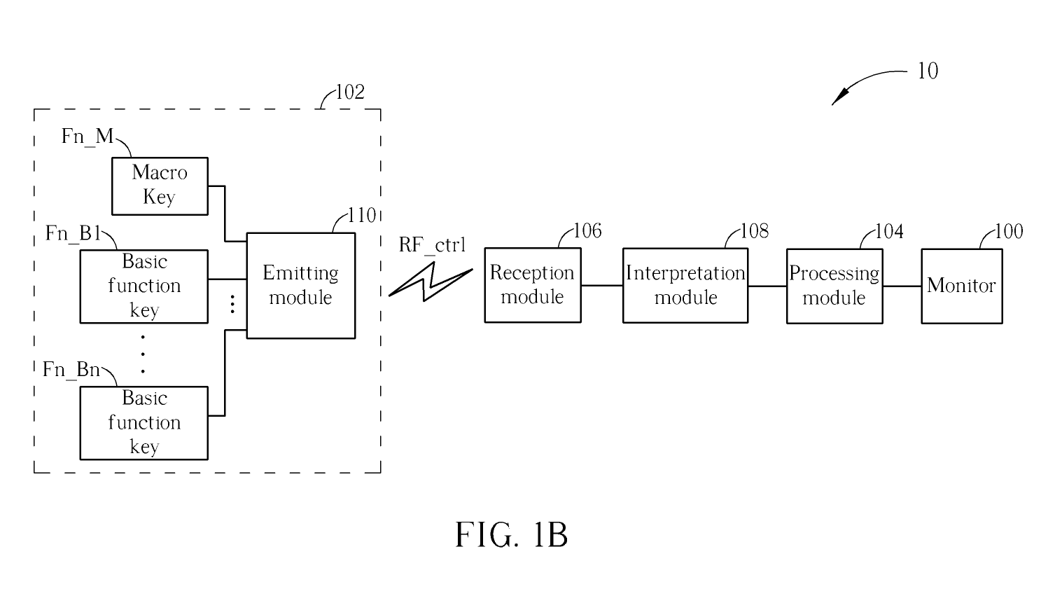

Please refer to FIG. 1A and FIG. 1B. FIG. 1A is a schematic diagram of a display device 10 according to an embodiment of the present invention, and FIG. 1B is a block diagram of the display device 10. As shown in FIG. 1A and FIG. 1B, the display device 10 employs a hierarchical control frame, and is preferably a TV set, but is not limited to TV set. The display device 10 includes a monitor 100, a remote controller 102, a processing module 104, a reception module 106, and an interpretation module 108. The remote controller 102 controls operations of the display device 10, and includes an emitting module 110, a macro key Fn_M and basic function keys Fn_B1-Fn_Bn. The macro key Fn_M and the basic function keys Fn_B1-Fn_Bn are utilized for generating control signals or commands, and outputting the generated control signals or commands as a wireless signal RF_ctrl via the emitting module 110. The reception module 106 is utilized for receiving the wireless signal RF_ctrl and extracting the control signal contained in the wireless signal RF_ctrl with adequate operations of demodulation, deciphering, etc. Accordingly, the interpretation module 108 determines the parameters or operations to be controlled, and adjusts or switches the processing module 104 to execute specific functions.

In the remote controller 102, the macro key Fn_M is used for generating a control signal corresponding to a plurality of functions, while each of the basic function keys Fn_B1-Fn_Bn is used for generating a control signal corresponding to a basic function. That is, the user can press the macro key Fn_M to trigger “multiple functions”, or press one of the basic function keys Fn_B1-Fn_Bn to trigger “a basic function”. Therefore, the basic function keys Fn_B1-Fn_Bn can be seen as common keys of the traditional remote controller, such as number keys 0-9, volume control keys, channel switching keys, etc. However, the macro key Fn_M is an exclusive design of the present invention, for executing or controlling multiple functions in the hierarchical control frame with a single key. Difference between these two operations is depicted with figures and narrated as follows.

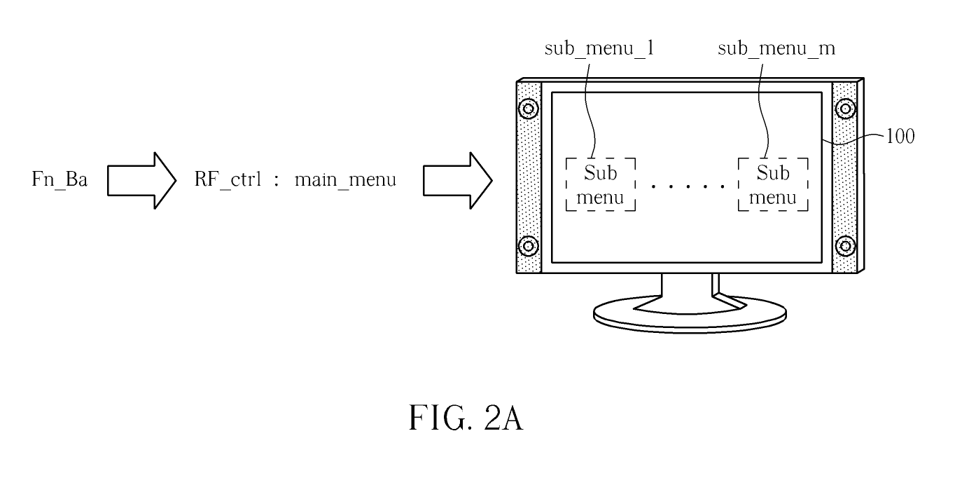

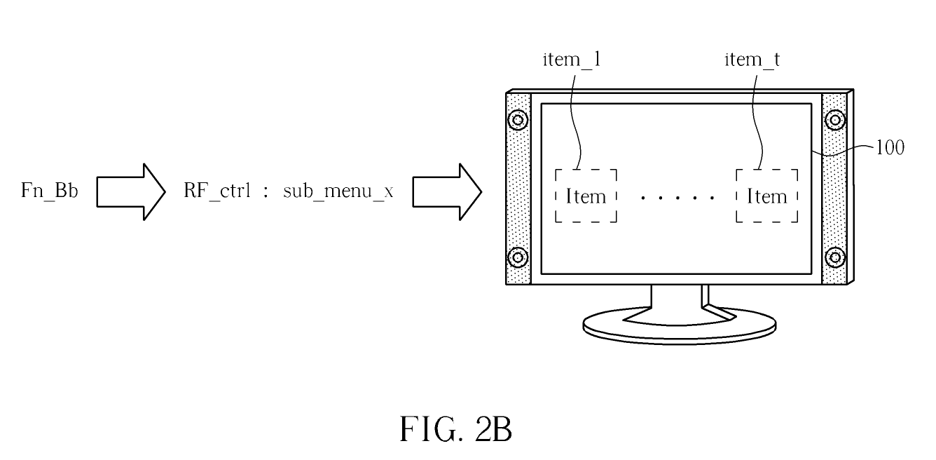

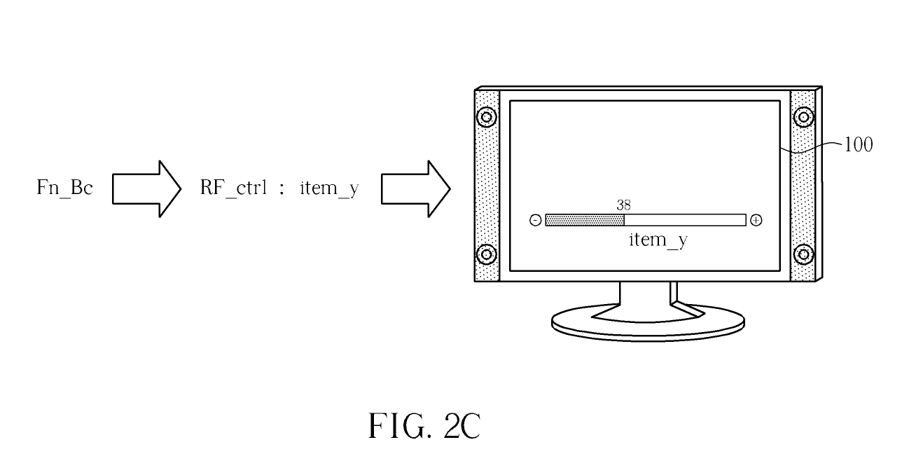

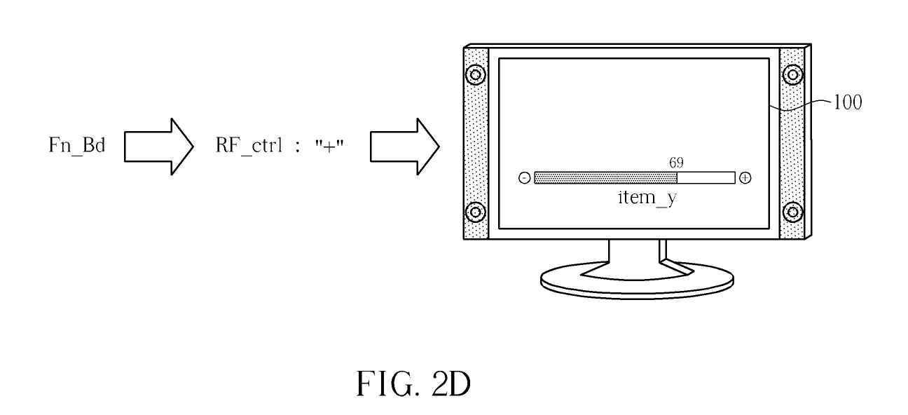

First, please refer to FIG. 2A to FIG. 2D. FIG. 2A to FIG. 2D illustrate an example that the user controls the display device 10 via the basic function keys Fn_B1-Fn_Bn. Assume that the user intends to adjust a certain function or parameter of the display device 10 from “38” to “69”. As illustrated in FIG. 2A, the user first presses a basic function key Fn_Ba among the basic function keys Fn_B1-Fn_Bn, making the remote controller 102 to output the wireless signal RF_ctrl containing a command main_menu to the reception module 106. Then, the interpretation module 108 controls the processing module 104 to display the main menu via the monitor 100. The main menu includes sub menus sub_menu_1-sub_menu_m; hence, as illustrated in FIG. 2B, the user selects a sub menu sub_menu_x via a basic function key Fn_Bb, making the processing module 104 to display contents of the sub menu sub_menu_x via the monitor 100, i.e. items item_1-item_t. An item item_y among the items item_1-item_t is corresponding to the function or parameter that the user intends to adjusted; hence, as illustrated in FIG. 2C, the user further selects the item item_y via a basic function key Fn_Bc. Finally, using a basic function key Fn_Bd, the user adjusts the value of the item item_y from “38” to “69”, as illustrated in FIG. 2D.

FIG. 2A to FIG. 2D are schematic diagrams of the display device 10 performing a traditional hierarchical control. The commands contained in the basic function keys Fn_Ba-Fn_Bd or the wireless signal RF_ctrl are denoted by main_menu, sub_menu_x, item_y, “+”, etc, to specify related operations, and may vary according to different system requirements. However, the denominations are not key issues of the present invention, and are abridged herein.

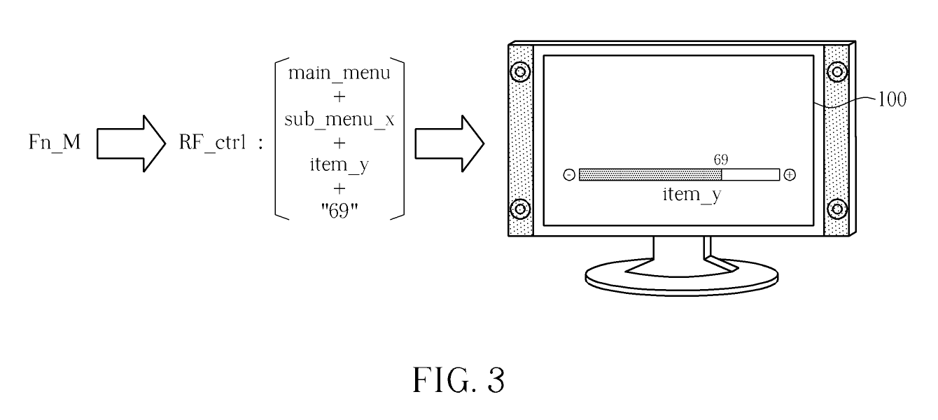

An example of the macro key Fn_M is as follows. Please refer to FIG. 3. Assume the user also intends to adjust the value of the item item_y from “38” to “69”. Once the macro key Fn_M is correctly defined, the user can adjust the value of the item item_y from “38” to “69” by merely pressing the macro key Fn_M. In other words, the control signal generated by the macro key Fn_M includes the commands main_menu, sub_menu_x, item_y, and “69”. Hence, the user can adjust the value of the item item_y to “69” by pressing the macro key Fn_M once, rather than entering menus step by step to select each function. Under such circumstances, the necessary operations can be simplified substantially, so as to enhance operational efficiency.

Note that, to execute multiple functions via the macro key Fn_M, the functions or items to be triggered by pressing the macro key Fn_M must be correctly set at first, and a setting module for performing the related setting steps can be implemented in various ways. For example, a setting key can be installed in the remote controller 102, for starting the setting steps of the macro key Fn_M, or implemented by the interpretation module 108. Performing such variations and modifications should be an ordinary skill for those skilled in the art. Besides, FIG. 3 invokes the wireless signal RF_ctrl including the commands main_menu, sub_menu_x, item_y, and “69” to depict the corresponding operations. In practice, it is merely an exemplary embodiment. Other single command or a combination of multiple commands controlling the processing module 104 to execute multiple functions are also feasible, as long as the reception module 106 is able to extract contents contained in the wireless signal RF_ctrl accurately, and the interpretation module 108 is able to determine the corresponding operations. In addition, to enhance security or data accuracy, a checking code can be added to the control signal generated by the macro key Fn_M, such as cyclic redundancy check code, checksum checking code, etc.

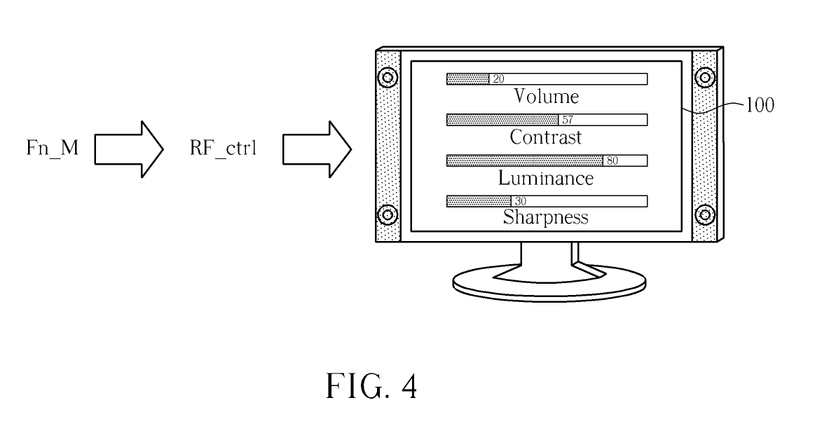

Furthermore, the macro key Fn_M mentioned above is utilized for specifying the concept of the present invention, whose denomination, quantity, contents, etc. are not limited. Also, the macro key Fn_M can further be applied for reaching versatile applications such as personalized settings. For example, FIG. 4 is a schematic diagram of using the macro key Fn_M to reaching fast personalized settings. If the user has set the macro key Fn_M to be used for adjusting the volume to “20”, contrast to “57”, luminance to “80”, and sharpness to “30”, when the user presses the macro key Fn_M, the above settings can be rapidly performed. Under such circumstances, the user does not have to go through the complicated hierarchical controls, but presses only the macro key Fn_M to reach the required settings. In addition, other macro keys can be added to meet setting requirements of different users, to reach the purpose of personalized settings.

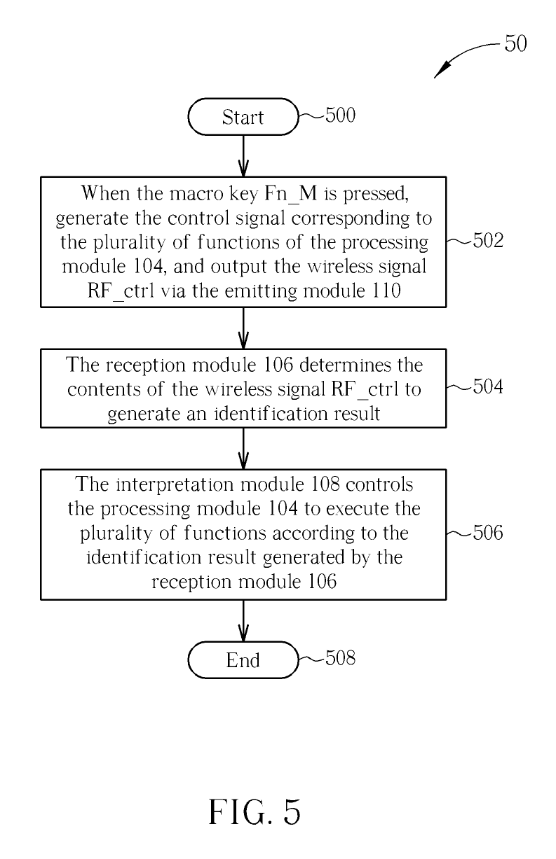

The above operations of the display device 10 can be concluded into a remote control process 50, as illustrated in FIG. 5. The remote control process 50 includes the following steps:

Step 500: Start.

Step 502: When the macro key Fn_M is pressed, generate the control signal corresponding to the plurality of functions of the processing module 104, and output the wireless signal RF_ctrl via the emitting module 110.

Step 504: The reception module 106 determines the contents of the wireless signal RF_ctrl to generate an identification result.

Step 506: The interpretation module 108 controls the processing module 104 to execute the plurality of functions according to the identification result generated by the reception module 106.

Step 508: End.

The remote control process 50 is utilized for interpreting the operations of the display device 10, and can be referred to the above narration for detail, and is not narrated herein.

In the prior art TV set employing the hierarchical control frame or similar display devices, the user has to undergo multiple stages of menus to control or adjust a single output parameter. Such operations lack flexibility, and cannot meet the requirement of personalized settings. In comparison, using the macro key, the present invention does not have to display each control menu, but rapidly adjusts a single or multiple output parameters at the same time. Also, the present invention can reach the purpose of personalized settings.

To sum up, the present invention is capable of effectively enhancing operational efficiency of the display device, and further fulfilling requirement of personalized settings.

Those skilled in the art will readily observe that numerous modifications and alterations of the device and method may be made while retaining the teachings of the invention.

What is claimed is:

1. A remote control method for a display device employing a hierarchical control frame, comprising:
a remote controller of the display device outputting a control signal corresponding to a plurality of functions of the display device; and
an interpretation module of the display device controlling the display device to perform the plurality of functions when receiving the control signal;
wherein the plurality of functions are corresponding to different stages of the hierarchical control frame.

2. The remote control method of claim 1, further comprising setting contents of the plurality of functions before the remote controller outputs the control signal.

3. The remote control method of claim 2, wherein the step of setting the contents of the plurality of functions is performed via the remote controller.

4. The remote control method of claim 2, wherein the step of setting the contents of the plurality of functions is performed via the interpretation module.

5. The remote control method of claim 1, wherein the control signal comprises a plurality of instructions, for controlling the plurality of functions in the hierarchical control frame.

6. The remote control method of claim 5, wherein the control signal further comprises a checking code.

7. A remote control system for a display device employing a hierarchical control frame, comprising:
a macro key, formed in a remote controller, for generating a control signal corresponding to a plurality of functions of the display device; and
an interpretation module, for controlling the display device to perform the plurality of functions when the display device receives the control signal generated by the macro key;
wherein the plurality of functions are corresponding to different stages of the hierarchical control frame.

8. The remote control system of claim 7, further comprising a setting module, for setting contents of the plurality of functions corresponding to the macro key.

9. The remote control system of claim 8, wherein the setting module is installed in the remote controller.

10. The remote control system of claim 8, wherein the setting module is installed in the interpretation module.

11. The remote control system of claim 8, wherein the control signal comprises a plurality of instructions, for controlling the plurality of functions in the hierarchical control frame.

12. The remote control system of claim 11, wherein the control signal further comprises a checking code.

13. A display device employing a hierarchical control frame, comprising:
a monitor;
a processing module, for displaying images via the monitor;
a remote controller, comprising:
an emitting module, for outputting a wireless signal; and
a macro key, for generating a control signal corresponding to a plurality of functions of the processing module, and outputting the control signal as the wireless signal via the emitting module;
a reception module, for receiving the wireless signal outputted from the remote controller and extracting contents of the wireless signal to generate an identification result; and
an interpretation module, for controlling the processing module to execute the plurality of functions when the identification result equals the control signal generated by the macro key;
wherein the plurality of functions are corresponding to different stages of the hierarchical control frame.

14. The display device of claim 13, wherein the remote controller further comprises a plurality of basic function keys, each for generating a control signal corresponding to a basic function of the processing module, and outputting the control signal corresponding to the basic function as the wireless signal via the emitting module.

15. The display device of claim 13, further comprising a setting module, for setting contents of the plurality of functions corresponding to the macro key.

16. The display device of claim 15, wherein the setting module is installed in the remote controller.

17. The display device of claim 15, wherein the setting module is installed in the interpretation module.

18. The display device of claim 13, wherein the control signal comprises a plurality of instructions, for controlling the plurality of functions in the hierarchical control frame.

19. The display device of claim 18, wherein the control signal further comprises a checking code.
